(19) United States
(12) Patent Application Publication
(10) Pub. No.: US 2025/0148638 A1
(43) Pub. Date: May 8, 2025

(54) SYSTEMS AND METHODS FOR SPACE OBJECT IDENTIFICATION

(71) Applicant: Martian Sky Industries, LLC, Cleveland Heights, OH (US)

(72) Inventors: Douglas Marsh, University Heights, OH (US); Wei Huang, Parma Heights, OH (US); Eric Coghill, Cleveland Heights, OH (US); Xavier Elder, Berea, OH (US)

(21) Appl. No.: 18/938,519

(22) Filed: Nov. 6, 2024

Related U.S. Application Data
(60) Provisional application No. 63/547,460, filed on Nov. 6, 2023.

(51) Int. Cl. G06T 7/70; G06V 20/13

(52) U.S. Cl. CPC G06T 7/70; G06V 20/13; G06T 2207/10032; G06T 2207/20081

(57) ABSTRACT

The disclosed technology relates, in general, to space object identification and characterization. More particularly, the disclosed technology relates to space object identification, analysis, characterization, and interaction systems and methods. Embodiments of the disclosed technology include a method of building one or more three-dimensional models of a target space object; determining spacecraft relative position and attitude for autonomous interaction; estimating the volume of the target object or segments of the target object; estimating mass of the target object or segments of the target object; and estimating momentum and moment of inertia properties of the target object or segments of the target object.

### CROSS REFERENCE TO RELATED APPLICATIONS

This application claims the benefit of U.S. Provisional Patent Application No. 63/547,460, filed on Nov. 6, 2023, the disclosure of which is hereby incorporated in its entirety.

### STATEMENT REGARDING FEDERALLY SPONSORED RESEARCH OR DEVELOPMENT

The inventions described herein were made with Governmental support under contract number 80NSSC21C0283 awarded by The National Aeronautics and Space Administration and contract number FA864923P0581 awarded by The Department of Defense. The government has certain rights in the inventions disclosed.

### BACKGROUND

Safely identifying and characterizing objects in outer space is critical. Identification and characterization allow for safer interactions, avoiding collisions, and improving knowledge in an unknown environment.

For reasons stated above, and for other reasons which can become apparent to those skilled in the art upon reading the present specification, there is a need for systems and methods that provide for characterizing space object properties. There is a particular need for identifying and characterizing space object properties such that space object models may be assembled and autonomous interactions with a space object may be enabled. The disclosed technology fulfills these and other needs, and addresses deficiencies in known systems and techniques.

### BRIEF DESCRIPTION OF THE DRAWINGS

The accompanying drawings, which are incorporated into and form a part of the specification, schematically illustrate one or more example implementations of the disclosed inventive subject matter and, together with the general description given above and detailed description given below, serve to explain the principles of the disclosed subject matter, and wherein:

FIG. 1 depicts a flowchart of an embodiment of an exemplary set of steps to build one or more three-dimensional models of a target space object;

FIG. 2 depicts a flowchart of an embodiment of an exemplary set of steps to build one or more three-dimensional models of a target space object;

FIG. 3 depicts a flowchart of the method from FIG. 2 further comprising determining servicer attitude, controlling attitude, segmenting the target space object into individual elements, and classifying the individual elements;

FIG. 4 depicts a flowchart of the method from FIG. 3 further comprising characterizing the material of a target space object and determining the volume and mass of the unknown object; and

FIG. 5 depicts an exemplary system for space object identification and characterization.

### DETAILED DESCRIPTION

Various non-limiting embodiments of the present disclosure are now described to provide an overall understanding of the principles of the structure, function, and use of the systems and methods as disclosed herein. One or more examples of these non-limiting embodiments are illustrated in the accompanying drawings. Those of ordinary skill in the art may understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment can be included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components.

The examples discussed herein are examples only and are provided to assist in the explanation of the systems and methods described herein. None of the features or components shown in the drawings or discussed below should be taken as mandatory for any specific implementation of any of these systems and methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination cannot be possible. Also, for any methods described, regardless of whether the method can be described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Space is cluttered with objects, both known and unknown. These objects can interfere with satellites, cause safety issues for those in space, or cause safety issues on Earth, among other issues. Identifying and characterizing these objects can allow for the removal of space objects that are classified as debris and improve the safety of the removal process. The identification and characterization of the objects can also allow for safer interactions with the objects other than removal of the objects.

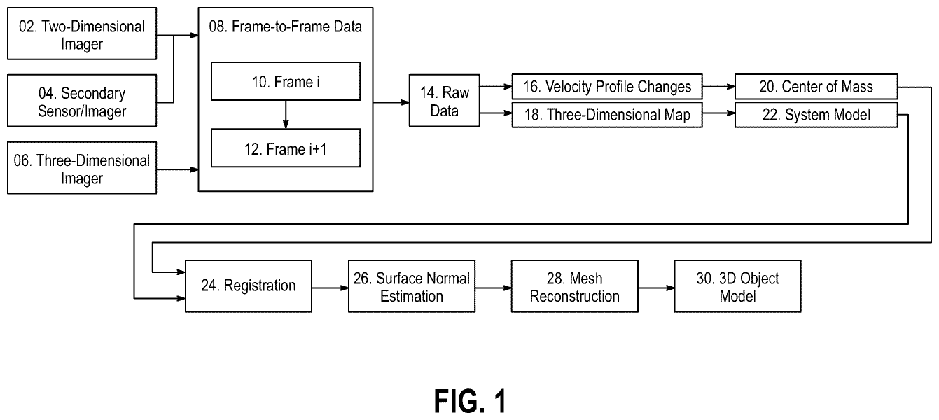

FIG. 1 depicts a flowchart of an exemplary set of steps to build one or more three-dimensional models of a target space object. Said target space object may be known or unknown, cooperative or uncooperative, and may be referred to as the target space object. There may be one or more target space objects in any given interaction. A first step (08) can be creating one or more image datasets of the target space object. Step (08) can include an imaging device taking images of the target space object as it rotates such that the one or more image datasets comprise a full view of the target space object. This could also include taking video of the target space object or taking individual images of the individual elements of the target space object, but not necessarily of the entirety of the target space object. The imaging device could be part of a servicer spacecraft utilized at a step (40). In one or more versions, the servicer spacecraft utilized at step (40) may be a spacecraft or satellite that is configured such that the spacecraft or satellite completes the entirety of the method autonomously, with machine learning integrated into the process, or where machine learning supports autonomy in the system. Machine learning may mean the use and development of computer systems that are able to learn and adapt without following explicit instructions, by using algorithms and statistical models to analyze and draw inferences from patterns in data. In another implementation, the servicer spacecraft used at step (40) may be a spacecraft or satellite that is configured to communicate with an external processor that completes aspects of the method then returns data to servicer spacecraft. In one or more versions, the one or more image datasets created at step (08) may include at least two images or frames (10)/(12) showing the target space object. The one or more image datasets created at step (08) may also include tracked points on the target space object. In one or more embodiments, the imaging device may be selected from the group consisting of optical telescopes, reflecting telescopes, refracting telescopes, radio telescopes, the Hubble Space Telescope, the Chandra X-ray Observatory, the Spitzer Space telescope, the James Webb Space Telescope, the Geostationary Operational Environmental Satellite, satellites for planetary exploration, robotic probes and landers, ground-based observatories, amateur telescopes, adaptive optics systems, infrared detectors, ultraviolet detectors, LiDAR sensors, space telescope imaging spectrograph, cameras, video-cameras, neuromorphic sensors, spacecraft cameras, x-ray sensors, and combinations thereof.

Next, a processor may receive the one or more image datasets created at step (08) and may process them such that the one or more image datasets are usable to find magnitude and direction change of the target space object's instantaneous velocity at a step (16) and to configure a partial three-dimensional map at a step (18) of the target space object. The three-dimensional map created at step (18) may comprise a point cloud, a point set, a list of points in three-dimensional space, a depth map, a set of surfels, a triangle mesh, a polygon mesh, a three-dimensional grid of cubic voxels, a three-dimensional grid of polyhedral voxels, other three-dimensional data, and combinations thereof. In other implementations, there may be a pre-filter applied to raw data created at a step (14) of the one or more image datasets created at step (08). The processor may use the tracked points from the one or more image datasets created at step (08) to determine the instantaneous velocity of the target space object created at step (16). In one or more embodiments, the processor may be selected from the group consisting of a central processing unit, a graphics processing unit, a microprocessor, a media processor, a tensor processing unit, a field-programmable gate array, a system-on-chip, an application-specific integrated circuit, a multi-core processor, a neural processing unit, a quantum processor, a cloud-based processor, and combinations thereof. In one or more versions, the processor is one or more central processing units, one or more graphics processing units, or combinations thereof.

The change in direction and magnitude of the target space object's instantaneous velocity determined at step (16) can then be used to determine the target space object's two-dimensional center of mass at a step (20). The more frames or images (10)/(12) in the one or more image datasets created at step (08), the more accurate the target space object's center of mass determination at step (20) can be. In one or more versions, the center of mass of the target space object may be found by using the one or more image datasets created at step (08) and the change in direction and magnitude of the target space object's instantaneous velocity determined at step 16 at various points on the target space object to identify the point about which the target space object is rotating. In one or more versions, the center at which the target space object may be rotating may be considered the center of mass for the purposes of the center of mass determination at step (20). In one or more embodiments, the two-dimensional center of mass determined at step (20) aligns with the target space object's three-dimensional center of mass. Thus, determining the two-dimensional center of mass at step (20) also finds the three-dimensional center of mass.

One or more three-dimensional maps of the target space object created at step (18) can also be assembled from the one or more image datasets created at step (08). The one or more three-dimensional maps created at step (18) could be point clouds, point sets, any other appropriate mapping mechanism, and combinations thereof. The one or more three-dimensional maps created at step (18) can then be transformed into one or more system models of the target space object at a step (22). This transformation may be done by analyzing the one or more partial three-dimensional maps created at step (18) and determining the changes in relative position, rotation, and velocity of the object about the target space object's two-dimensional center of mass created at step (20) to aid in alignment and registration of the partial three-dimensional maps created at step (18) to form a more complete 3D object model. The one or more system models of the target space object created at step (22) may include objects outside of the target space object. These objects could include servicer spacecraft utilized at step (40), nearby space debris, satellites, spacecrafts, moons, planets, other space objects, and combinations thereof. The processor then registers at a step (24) the one or more system models created at step (22) and the three-dimensional maps created at step (18) and may also utilize the center of mass determination created at step (20) such that an accurate three-dimensional model of the target space object can be rendered at a step (30). The three-dimensional model of the target space object created at step (30) can be rendered using surface mapping, mesh reconstruction (28), interpolation, Lidar mapping, photogrammetry, time-of-flight imaging, structured light scanning, other reasonable mapping methods, and combinations thereof to render an accurate portrayal of the target space object. The rendered three-dimensional model created at step (30) may require estimation of outward-point surface normal vectors at a step (26) to complete mesh reconstruction.

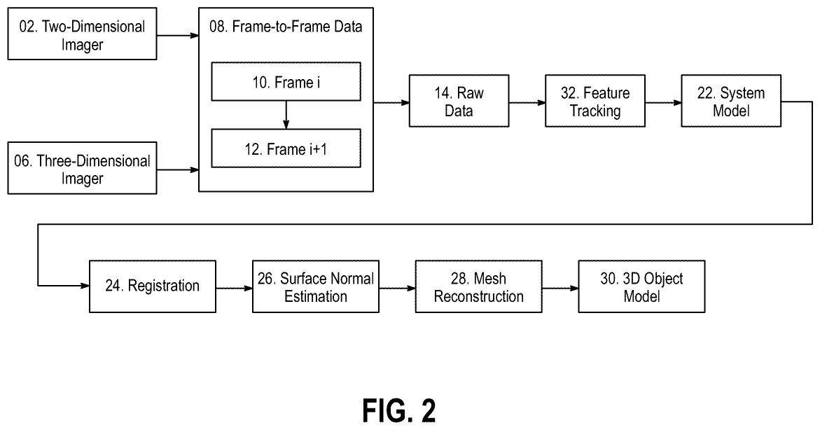

FIG. 2 depicts an embodiment of an exemplary set of steps to build one or more three-dimensional models of a target space object using feature tracking at a step (32) of geometry between frames (10), (12) in order to register three-dimensional maps from raw data at step (14) to create a more complete three-dimensional map ready for mesh reconstruction at step (28). In one or more embodiments, feature tracking at step (32) may include identification of distinct three-dimensional geometry, colors, textures, and/or other features that can be recognized between frames (10), (12). The tracked features utilized in step (32) may be used to produce a transformation matrix describing the relative motion of the target object between consecutive measurements.

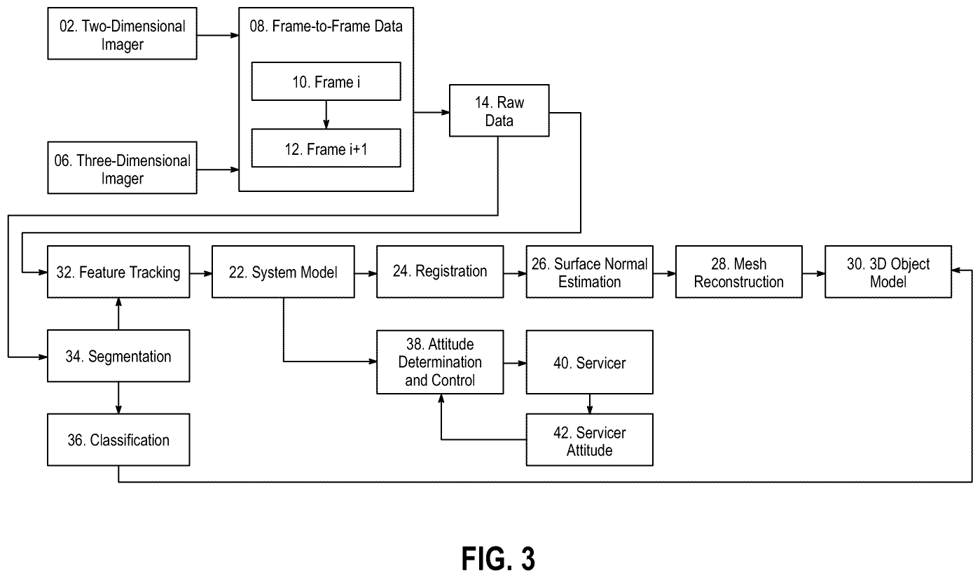

FIG. 3 depicts a flowchart of the method from FIG. 2 further comprising determining servicer attitude at a step (42), controlling attitude at a step (38), segmenting the target space object into individual elements at a step (34), and classifying the individual elements at a step (36). Attitude may be the angular orientation of a spacecraft or object in space. In this implementation, the one or more three-dimensional maps in the form of raw data from step (14) may also be used to segment at step (34) and to classify at step (36) the elements of the target space object. The segmented and classified version of the one or more three-dimensional maps created at steps (34) and (36) can then be used to further render and/or provide detail for the three-dimensional model of the target space object at step (30).

Beyond the segmentation process at step (34), this implementation may also use the one or more system models created at step (22) to provide key information about both the target space object and the servicer spacecraft used at step (40) at step (38) The servicer's attitude determination and control utilized at step (38) may use the information from the one or more system models created at step (22) of the target space object to adjust the servicer's attitude at step (42). These adjustments may allow the servicer spacecraft used at step (40) to interact safely with the target space object. The servicer's attitude determination and control utilized at step (38) may be autonomous determination and control to adjust the flight path of the servicer spacecraft to keep a proper trajectory by controlling an actuator that is part of the servicer spacecraft. The attitude determination and control at step (38) may also be autonomously determined and controlled to adjust the servicer spacecraft at step (40) based on continuous updates of the one or more system models at step (22).

The one or more system models utilized at step (22) of the target space object may include one or more possible interaction paths for the servicer spacecraft adjusted at (40) to interact with the target space object. The processor could determine the optimal interaction point for the adjustment of servicer spacecraft at step (40) to interact with the target space object based on a center of mass determination at step (20). After determining the optimal interaction point, the processor may render an optimal flight path for the servicer spacecraft to take at step (40) such that the servicer spacecraft can travel to the target space object in the safest, or other determined priority, way. In other implementations, the one or more possible interaction paths may be sent to an external device for manual selection. The owner or operator of the servicer may choose whether the interaction paths should be selected by the processor autonomously or sent to an external device for manual selection. Some implementations may be configured to only send path selection options to external devices when all path options have a certain level of potential hazards. The servicer spacecraft from step (40) may interact with the target space object with an actuator, probe, or other tool to interact with the space object.

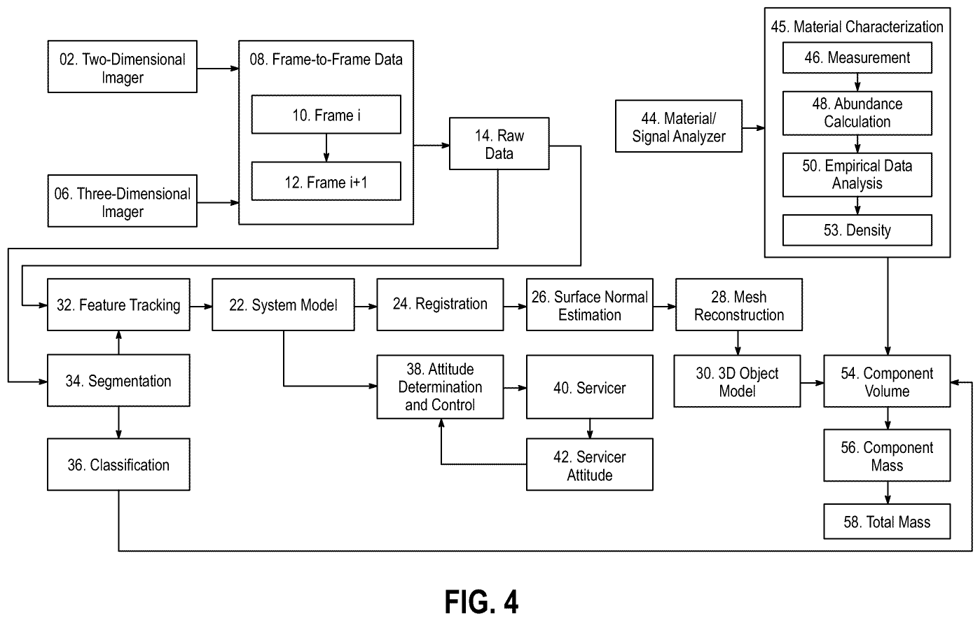

FIG. 4 depicts a flowchart of the method from FIG. 3 further comprising characterizing the material of the target space object at a step (45), determining the volume of the target space object at a step (54), the component mass of the target space object at a step (56), and the total mass of the target space object at a step (58). In FIGS. 1 and 4, two-dimensional (02) or three-dimensional (04) image signal types may be the output from an imaging device as discussed in the description of FIGS. 1 and 2. The one or more image datasets created by the imaging device at step (08) can produce a two-dimensional signal type at a step (02) and/or a three-dimensional signal type at a step (04). Material characterization signals may be created at a step (44) and these material characterization signals may be any output from a material sampling device or method, like contact analysis, standoff analysis, or any other reasonable analysis method. The material characterization process at a step (45) may include obtaining a sample of the target space object, measuring the material sample at a step (46), calculating the target space object's abundance at a step (48), and/or performing empirical data analysis at a step (50). The results of the steps previously listed may be used by the processor to determine the most likely material that the target space object can be made of, allowing for an estimate of the target space object's density at a step (52) at the measured point. This may allow the processor to use the results of the material characterization process to determine what type of object the space object could be (i.e., a satellite, space debris, etc.). This may be done by utilizing the material characterization results created at step (45) with other information like the one or more three-dimensional models of the unknown object created at step (30).

Obtaining a sample of the target space object may be done by contact analysis, standoff analysis, any other reasonable analysis method, or any combination thereof. Contact analysis allows the servicer spacecraft at step (40) to directly interact with the target space object. Contact analysis allows for a direct sample of the target space object to be collected such that the sample could be tested offsite, or otherwise away from the target space object. This could also allow for multiple samples to be collected, and some could be brought back to a separate spacecraft or satellite for testing.

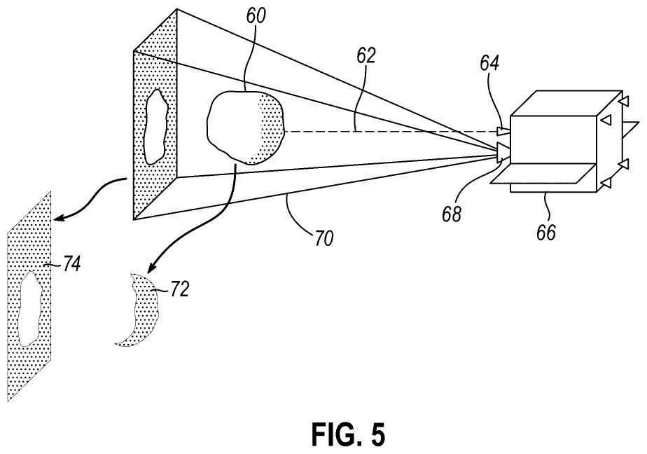

Standoff analysis can be another way to take material samples and has different benefits than contact analysis. Standoff analysis may allow for the material characterization created at step (45) to take place at remote distances. The ability to characterize the target space object's material at a distance adds a level of safety to the material characterization process that takes place at step (45). Especially since the space object can be unknown, it may be beneficial to use standoff analysis as a means to minimize interactions with hazardous or otherwise harmful materials or objects. Standoff analysis may also allow the target space object to be identified prior to potentially collecting samples up close. This can be accomplished with spectral measurements or reflective properties, such as those taken with a reflectance measuring laser (62) as shown in FIG. 5, with the data from said measurements compared to a library of material data to determine a probabilistic estimate of the material composition. Said library of material data may be curated based on mission type, wherein analysis of satellites or other spacecraft utilizes a library of materials typical in construction of satellites or spacecraft, and analysis of naturally occurring space objects like asteroids, comets, or small debris would rely on a differently curated reference library.

The result of the material characterization process can then be used in combination with the one or more three-dimensional models of the unknown object created at step (30), the segmentation determined at step (34), and classification results determined at step (36) as shown in FIG. 3 to find the volume of each component of the target space object at step (54). Component volume may include an estimate of unseen target object construction parameters or composition. The individual volumes can then be used along with the density estimate determined at step (52) to find the estimated mass of the individual components at step (56). The individual mass results can then be used to calculate the total mass of the target space object at step (58). Continued frame to frame tracking of frames (10), (12) combined with the 3D object model created at step (30) and the total mass determined at step (58) can be used to estimate momentum and moment of inertia properties.

In one or more embodiments, with the total mass determined at step (58) and the three-dimensional model of the target space object rendered at step (30), the owner or operator of the servicer can decide, or the processor can autonomously decide what the next step would be for the servicer spacecraft adjustment at step (40) with that particular target space object. The next step may be for the servicer spacecraft utilized at step (40) to begin on a path to interacting more heavily with the target space object. This may mean removing the target space object if it is determined to be space debris; sending signals to the target space object if it is determined to be a satellite of interest; carefully moving the target space object in a path determined by the owner, operator, or autonomously by the processor; or leaving the target space object alone.

FIG. 5 provides a visualization of a basic embodiment of the system. A servicer craft (66), a target object (60), sensors (64, 68), fields of view of said sensors (70), and a resulting three-dimensional map (72) are shown. In other embodiments, a different number or type of sensors (64, 68) may be used by one or more servicer crafts (66), and may be used to generate partial three-dimensional maps (72) of one or more target objects (60), wherein such target objects (60) may be known or unknown, and may be naturally-occurring space objects or satellites or spacecraft in whole or part.

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the examples below. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

Example 1 may be a system of space object characterization comprising: one or more imaging devices operable to produce a set of data indicating properties of a target space object comprising: shape, location, and orientation; a processor configured to: receive image data from the one or more imaging devices; assemble one or more partial three-dimensional maps of the target space object; combine said one or more partial three-dimensional maps to produce a more complete three-dimensional map; and formulate a system model based on the combined three-dimensional map for characterization of the target space object.

Example 2 may be the system according to Example 1, further comprising a tool to interact with the target space object.

Example 3 may be the system according to Example 1, wherein the set of data produced by the one or more imaging devices is a two-dimensional data set.

Example 4 may be the system according to Example 1, wherein the set of data produced by the one or more imaging devices is a three-dimensional data set.

Example 5 may be the system according to Example 1, wherein the processor is further configured to assess inertial or kinematic properties of the target space object.

Example 6 may be the system according to Example 1, wherein the processor is further configured to assess volumetric properties of the target space object.

Example 7 may be the system according to Example 1, further comprising a control system capable of changing the attitude and position of the one or more imaging devices using information from a target spacecraft system model to maintain a relative pose between the one or more imaging devices and the target space object.

Example 8 may be the system according to Example 7, wherein said control system facilitates direct interaction between said system according to example 7 and the target by means of a tool configured to interact with the target object.

Example 9 may be the system according to Example 1, further comprising one or more sensors capable of assessing a spectral signature of materials on a surface of the target object.

Example 10 may be a method for space object identification, the method comprising: creating one or more image datasets of a target space object; determining a change in relative position and attitude of the target space object based on the one or more image datasets; compiling one or more partial three-dimensional maps of the target space object; aligning said three-dimensional maps into a more complete three-dimensional map; and formulating one or more system models of the target space object for identification of the target space object.

Example 11 may be the method according to Example 10, further comprising rendering an accurate three-dimensional model of the target space object.

Example 12 may be the method according to Example 10, further comprising estimating a center of mass of the target space object based on the change of relative position and attitude of the target space object.

Example 13 may be the method according to Example 10, wherein aligning said partial three-dimensional maps includes using a filter.

Example 14 may be the method according to Example 10, wherein features on the partial three-dimensional maps of the target space object are tracked between time steps to aid in alignment of the partial three-dimensional maps.

Example 15 may be the method according to Example 10, wherein the partial three-dimensional maps are aligned through the use of an Iterative Closest Point (ICP) algorithm.

Example 6 may be the method according to example 10, further comprising identifying segments of the target space object having distinct functions or appearances in the partial three-dimensional maps by utilizing probabilistic identification.

Example 17 may be the method according to Example 16, wherein the identified segments are components of a satellite or space vehicle.

Example 18 may be the method according to Example 16, wherein segments are further identified through the use of machine learning.

Example 19 may be the method according to Example 10, wherein the one or more image datasets include reflectance data; wherein the reflectance data is used to estimate observed materials through the use of machine learning; and wherein the reflectance data includes calculated volume and density estimates.

Example 20 may be the method according to Example 19, further comprising estimating a target space object mass based on the calculated volume and density measurements.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein can be combined would be readily apparent to those of ordinary skill in the art in view of the teachings herein. Such modifications and variations are intended to be included within the scope of the claims.

Having shown and described various embodiments of the present disclosure, further adaptations of the methods and systems described herein may be accomplished by appropriate modifications by one of ordinary skill in the art without departing from the scope of the present disclosure. Several such potential modifications have been mentioned, and others can be apparent to those skilled in the art. For instance, the examples, embodiments, geometrics, materials, dimensions, ratios, steps, and the like discussed above are illustrative and are not required. Accordingly, the scope of the present disclosure should be considered in terms of the following claims and should be understood not to be limited to the details of structure and operation shown and described in the specification and drawings.

What is claimed:

1. A system of space object characterization comprising:
a. one or more imaging devices operable to produce a set of data indicating properties of a target space object comprising: shape, location, and orientation;
b. a processor configured to:
i. receive image data from the one or more imaging devices;
ii. assemble one or more partial three-dimensional maps of the target space object;
iii. combine said one or more partial three-dimensional maps to produce a more complete three-dimensional map; and
iv. formulate a system model based on the combined three-dimensional map for characterization of the target space object.

2. The system according to claim 1, further comprising a tool to interact with the target space object.

3. The system according to claim 1, wherein the set of data produced by the one or more imaging devices is a two-dimensional data set.

4. The system according to claim 1, wherein the set of data produced by the one or more imaging devices is a three-dimensional data set.

5. The system according to claim 1, wherein the processor is further configured to assess inertial or kinematic properties of the target space object.

6. The system according to claim 1, wherein the processor is further configured to assess volumetric properties of the target space object.

7. The system according to claim 1, further comprising a control system capable of changing an attitude and position of the one or more imaging devices using information from a target spacecraft system model to maintain a relative pose between the one or more imaging devices and the target space object.

8. The system according to claim 7, wherein said control system facilitates direct interaction between said system according to claim 7 and the target by means of a tool configured to interact with the target object.

9. The system according to claim 1, further comprising one or more sensors capable of assessing a spectral signature of materials on a surface of the target object.

10. A method for space object identification, the method comprising:
a. creating one or more image datasets of a target space object;
b. determining a change in relative position and attitude of the target space object based on the one or more image datasets;
c. compiling one or more partial three-dimensional maps of the target space object;
d. aligning said three-dimensional maps into a more complete three-dimensional map; and
e. formulating one or more system models of the target space object for identification of the target space object.

11. The method according to claim 10, further comprising rendering an accurate three-dimensional model of the target space object.

12. The method according to claim 10, further comprising estimating a center of mass of the target space object based on the change of relative position and attitude of the target space object.

13. The method according to claim 10, wherein aligning said partial three-dimensional maps includes using a filter method.

14. The method according to claim 10, wherein features on the partial three-dimensional maps of the target space object are tracked between time steps to aid in alignment of the partial three-dimensional maps.

15. The method according to claim 10, wherein the partial three-dimensional maps are aligned through the use of an Iterative Closest Point (ICP) algorithm.

16. The method according to claim 10, further comprising identifying segments of the target space object having distinct functions or appearances in the partial three-dimensional maps by utilizing probabilistic identification.

17. The method according to claim 16, wherein the identified segments are components of a satellite or space vehicle.

18. The method according to claim 16, wherein segments are further identified through the use of machine learning.

19. The method according to claim 10, wherein the one or more image datasets include reflectance data; wherein the reflectance data is used to estimate observed materials through the use of machine learning; and wherein the reflectance data includes calculated volume and density estimates.

20. The method according to claim 19, further comprising estimating a target space object mass based on the calculated volume and density measurements.
